(19) United States
(12) Patent Application Publication
(10) Pub. No.: US 2010/0149145 A1
(43) Pub. Date: Jun. 17, 2010

(54) DISPLAY PANEL

(75) Inventors: Roel Van Woudenberg, Eindhoven (NL); Rogier Cortie, Eindhoven (NL); Guofu Zhou, Eindhoven (NL); Mark Mertens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,738

(22) PCT Filed: Mar. 22, 2006
(86) PCT No.: PCT/IB2006/050879

§ 371 Date: Sep. 26, 2007

(30) Foreign Application Priority Data
Apr. 1, 2005 (EP) 05102588.0

(51) Int. Cl. G09G 5/10; G06F 3/038

(52) U.S. Cl. 345/207; 345/690

(57) ABSTRACT

The reflective display panel (1), arranged to modulate ambient light for displaying an image, has a pixel (2) and a controller (10,11,100). For the panel (1) to be able to display an image having a flexibly adjusted perceived brightness, the controller (10,11,100) is arranged for providing the pixel (2) with a brightness corresponding to image content and depending on a condition of the ambient light for displaying the image.

The invention relates to a reflective display panel for displaying an image.

The invention also relates to a display device comprising such a display panel.

The invention further relates to a controller for such a display panel, a method for driving such a display panel, and a computer program.

A reflective display panel of the type mentioned in the opening paragraph is a reflective electrophoretic display panel.

Reflective electrophoretic display panels in general are based on the motion of charged, usually colored particles in a fluid under the influence of an electric field between electrodes. With these display panels, dark or colored characters can be imaged on a light or colored background, and vice versa. These display panels are therefore notably used in display devices taking over the function of paper, referred to as “paper white” applications, e.g. electronic newspapers and electronic diaries.

A reflective electrophoretic display panel is disclosed in U.S. Pat. No. 6,704,113. The disclosed electrophoretic display panel has a plurality of pixels, each pixel having a brightness depending on the position of the particles in the pixel. Electrodes are arranged at the front plate and back plate of the display panel. A pixel has an extreme brightness when the particles occupy an extreme position near one of the electrodes, and a pixel has an intermediate brightness when the particles occupy one of the intermediate positions in between the electrodes. If e.g. a pixel has black particles in a white fluid, and the black particles are near the electrode at the front plate, then the black particles absorb the ambient light. As a consequence the pixel has an extreme brightness being black. If, however, the black particles are present near the electrode at the back plate, the white fluid covers the particles and the ambient light is reflected by the white fluid, resulting in another extreme brightness being white. An intermediate brightness is a brightness in between the extreme brightnesses.

The potential differences received by the electrodes are controlled for providing each pixel with a brightness for displaying the image. However, the image is not always well viewable by a viewer. For instance, under bright ambient light conditions, e.g. bright sunlight, the perceived brightness of the image by the viewer can be too high. At least partly shielding the image from the ambient light reduces this problem. However, this is a cumbersome solution.

It is an object of the invention to provide a reflective display panel of the kind mentioned in the opening paragraph which is able to display an image having a flexibly adjusted perceived brightness.

To achieve this object, the invention provides a reflective display panel arranged to modulate ambient light for displaying an image, comprising a pixel and a controller, the controller being arranged for rendering the pixel with a brightness corresponding to image content and depending on a condition of the ambient light for displaying the image. As the brightness depends on a condition of the ambient light, and adjusting the brightness by a controller is a flexibly way of adjusting the brightness, the image has a flexibly adjusted perceived brightness. The controller may be arranged for controlling the brightness in dependence of e.g. a color or direction of the ambient light.

In an embodiment the controller is arranged for controlling the brightness in dependence of an intensity of the ambient light. If, furthermore, the brightness is a decreasing function of the intensity, then the pixel is relatively dark (independent of the image content) under relatively bright ambient light conditions. This results in a relatively comfortable reading experience under e.g. bright sunlight conditions. It is not evident if one realizes that an image displayed on a display panel can be made brighter (which is usually desired to combat against the deleterious effects of outside illuminances such as the sun), that it can also be made darker. Apparently, long since a need existed, but users were restricted in their options of countering the blinding effect of too much reflecting illumination to e.g. tilt the display panel so that less of the impinging light reflects towards their eyes. However in practice, the display panel needs then to be tilted to such an extent that the content is also difficult to read. Furthermore, this is a very impractical way to read, as practice shows that people start turning their heads and bodies in an uncomfortable position which may lead to slight pain if the position is maintained for longtime. Also when using a portable display panel of larger dimensions it is not easy to keep it in the tilted position for a long time. Another option is to use sunglasses, but the present invention is particularly interesting in case a user has left his sunglasses at home (for example in the winter time people do not customarily bring sunglasses but the sun can start shining anyway, almost as bright as during the summer).

With the present invention one has a full opportunity to render an image as one desires, not just as in the classical paradigm so that an image looks optimally beautiful (which criterion determines the tone reproduction curves of the different color channels), but also so that the effect of a part of an image (e.g. only the lighter parts) on the straining of the eye of the viewer is controlled.

By putting the function of the sunglasses inside the display panel much more options emerge. Sunglasses just give a frequency dependent reduction, to a first approximation the luminance of each pixel in the image is reduced by an equal amount (which would also occur with the straightforward solution to provide for a covering filter, which e.g. can be pulled over the display panel). However with the present invention the luminance of each pixel can be reduced independently based on whatever a priori optimized criterion (for example depending on the position of a luminance in a gray value in the histogram of the entire image, mutatis mutandis on its color, on the gray values or colors of neighboring pixels, etc).

Furthermore the present invention also introduces different technical ways of thinking. If one for example reduces the white level of the display panel all the grays below have to be reduced correspondingly. Hence, the reproducible contrast of the display panel has gone down. One can anticipate this by performing an optimized gamut mapping on the image to be displayed. E.g., if only the lowest 20% of the driving values are used, it is advantageous to first perform a posterizing operation on the image. In the simplest variant of posterizing gray values are mapped to a fixed number of final gray values (the spacing of which was well-chosen dependent on the visual sensitivity for the present reflecting luminance range) depending on their distance to these gray values. Ideally smarter gamut mappings are used taking into account the video content. E.g. with text, a mapping is done to the two most optimally visible colors, i.e. a light gray that is not straining the eyes, and a dark gray that is not straining the eyes (i.e. it is well above the undesired reflection level on e.g. a glass cover plate, but still far from the light gray).

For pictures of faces a smart gamut mapping to a few colors/gray values of similarly optimal positions regarding visibility and strain under the present luminance regime (a base color, a few colors to render face textures and shadows, and a highlight reflection color), or even a cartoonizing (the face is rendered as a cartoon with only a base color and some accents). Especially the first case is rather acceptable, since the eye is very tolerant, and especially more so under high illumination (so the trade-off may be made in this way).

If the function is substantially linear, then the functional dependency can relatively easily be implemented. If the function is a logarithm, then the functional dependency is better adjusted to the sensitivity of the eye.

In another embodiment the brightness is:

a constant function of the intensity if the intensity is below a predetermined intensity, and

a decreasing function of the intensity if the intensity is larger than the predetermined intensity. Then the pixel is also relatively dark (independent of the image content) under relatively bright ambient light conditions, resulting in a relatively comfortable reading experience under e.g. bright sunlight conditions. This functional dependency can also relatively easily be implemented.

In another embodiment the controller comprises drive means and pixel electrodes for receiving a drive signal, the drive means being arranged to supply the drive signal for controlling the brightness for displaying the image. Such kind of controller can easily be manufactured. The dependence on the condition of the ambient light can be incorporated in several ways. In an embodiment the drive means comprises

an image content transformer for transforming the image content into a transformed image content, the transformed image content corresponding to the image content in dependence of the condition of the ambient light; and

a transformed image content drive waveform generator for generating a drive signal corresponding to the transformed image content, the drive signal corresponding to the transformed image content being supplied as the drive signal for controlling the brightness for displaying the image. Then the image content is transformed allowing a straightforward way of generating the drive signal. In a variation on the embodiment the image content transformer is arranged to apply a gamut mapping to the image from the original displayed driving gamut (e.g. R,G,B=[0, 255]) to a reduced driving gamut, determined as a function of the intensity. If, furthermore, the reduced driving gamut consists of a number of driving value combinations predetermined as being optimal regarding a balance between visibility and eye strain, then the reading experience is further optimized.

In another embodiment the drive means comprises

an image content drive waveform generator for generating a drive signal corresponding to the image content; and

a drive waveform transformer for transforming the drive signal corresponding to the image content into a transformed drive signal in dependence of the condition of the ambient light, the transformed drive signal being supplied to the pixel as the drive signal for controlling the brightness for displaying the image. Then the way of generating the drive signal is transformed allowing a straightforward way of supplying the image content. In another embodiment, the drive signal is an electrical current, for e.g. a current-addressed pixel. In an alternative, the drive signal is a potential difference.

In another embodiment the display panel comprises a front light for generating light contributing to the ambient light. Then the display panel has an increased readability. In a variation on the embodiment the controller is able to control the light generated by the front light in dependence of the ambient light. Then the display panel is even more flexible in its use, as this method improves use at low light levels, e.g. in dark shades or even darkness.

The reflective display panel can e.g. be an LCD panel—preferably a bistable LCD such as a bistable nematic or cholesteric LCD-, an electrochrome display panel, and a micro electromechanical system (MEM).

In an embodiment the pixel comprises two liquids positioned over a reflective surface, the brightness depends on a relative coverage of the surface by the liquids, and the controller is arranged to control the relative coverage for displaying the image. This is e.g. a electrowetting display panel. Such a display panel can relatively easily be used for video applications because of its short response times.

In another embodiment the pixel comprises charged particles, the brightness depends on an orientation of the particles, and the controller is arranged to control the orientation of the particles for displaying the image. This is e.g. a twisting ball display panel (Gyricon). Such a display panel has good paper-like/white display properties.

In another embodiment the pixel comprises an electrophoretic medium comprising charged particles, the brightness depends on a position of the particles, and the controller is arranged to control the position of the particles for displaying the image. This is e.g. an electrophoretic display panel. Such a display panel has even better paper-like/white display properties.

In a variation on the embodiment the controller comprises drive means and pixel electrodes for receiving a potential difference, the drive means being arranged to supply the potential difference for controlling the position of the particles for displaying the image.

In another embodiment the pixel is one of a plurality of pixels and the controller is arranged for providing the pixels with brightnesses corresponding to the image content relating to the pixels and depending on the condition of the ambient light for displaying the image. In a variation on the embodiment the controller is arranged for controlling the brightnesses of the pixels in dependence of an intensity of the ambient light. If, furthermore, a sum of the brightnesses is a decreasing function of the intensity, then, on average, the pixels are relatively dark (independent of the image content) under relatively bright ambient light conditions. This results in a relatively comfortable reading experience under e.g. bright sunlight conditions. This gives e.g. black characters on a light or dark grayish background. In another way of obtaining a relatively comfortable reading experience under bright sunlight conditions the brightnesses correspond to brightness inverted image content. This gives e.g. white characters on a gray or black background.

Apart from electronic reading applications like electronic-book (e-book), e-magazine and e-newspapers, electrophoretic display panels can form the basis of a variety of applications where information may be displayed, for example in the form of information signs, e.g. driven as one pixel, public transport signs, advertising posters, pricing labels, shelf labels, billboards etc. In addition, they may be used where a changing non-information surface is required, such as wallpaper with a changing pattern or colour, especially if the surface requires a paper like appearance.

Another aspect of the invention provides a display device comprising the display panel as claimed in claim 1 and a circuitry to provide image information to the display panel. In an embodiment the device has a soft or hard button for allowing a user to adjust the brightness of the screen according to personal taste.

Another aspect of the invention provides a controller for a reflective display panel, the display panel being arranged to modulate ambient light for displaying an image, comprising a pixel, the controller being arranged for providing the pixel with a brightness corresponding to image content and depending on a condition of the ambient light for displaying the image.

Another aspect of the invention provides a method for driving a reflective display panel, the display panel being arranged to modulate ambient light for displaying an image, comprising a pixel, the method comprising the step of providing the pixel with a brightness corresponding to image content and depending on a condition of the ambient light for displaying the image.

Another aspect of the invention provides a computer program comprising program code means for performing a method in accordance with the method as claimed in claim 26 when said program is run on a computer.

The mere fact that certain measures are mentioned in different claims does not indicate that a combination of these measures cannot be used to advantage.

These and other aspects of the display panel of the invention will be further elucidated and described with reference to the drawings, in which:

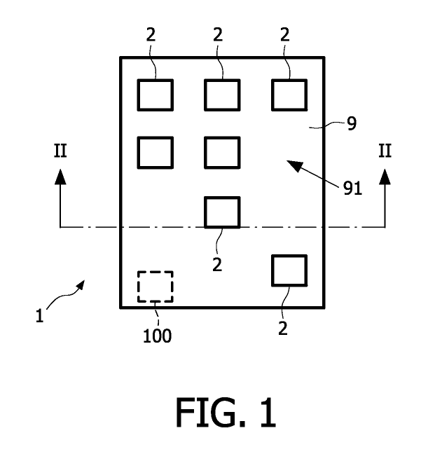

FIG. 1 shows diagrammatically a front view of an embodiment of the display panel;

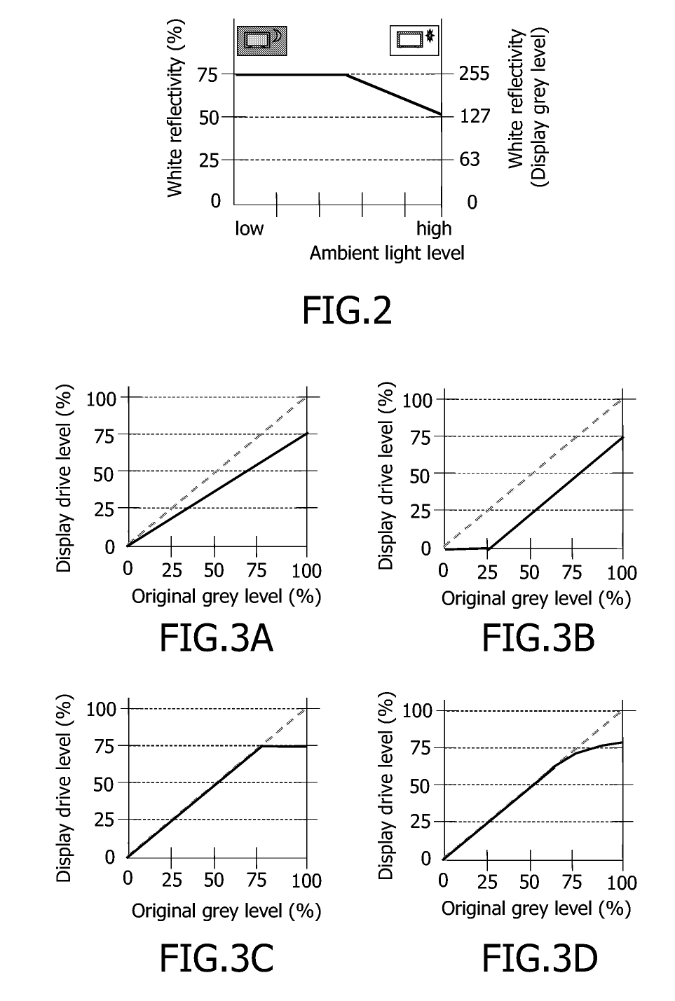

FIG. 2 shows the ambient light dependent maximum display reflectivity, for a display with a reflectivity of 75% in its full-white state. With low levels, conditions as for indoor viewing are meant; with high ambient levels, conditions like outdoor viewing in bright sunlight are meant;

FIGS. 3A-3D show strategies for reducing the display brightness under bright sunlight conditions. Percentages shown are percentages of the drive level;

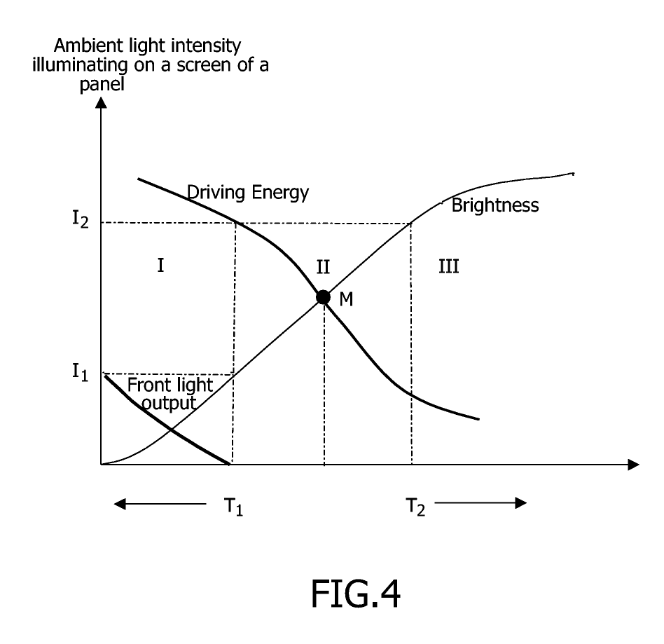

FIG. 4 shows schematic a correlation between the ambient light intensity and brightness using a predefined driving energy indicated at point M; a correlation between the ambient light intensity and driving energy for obtaining a brightness indicated at point M and a front light with controllable various output at a lighting intensity below I1;

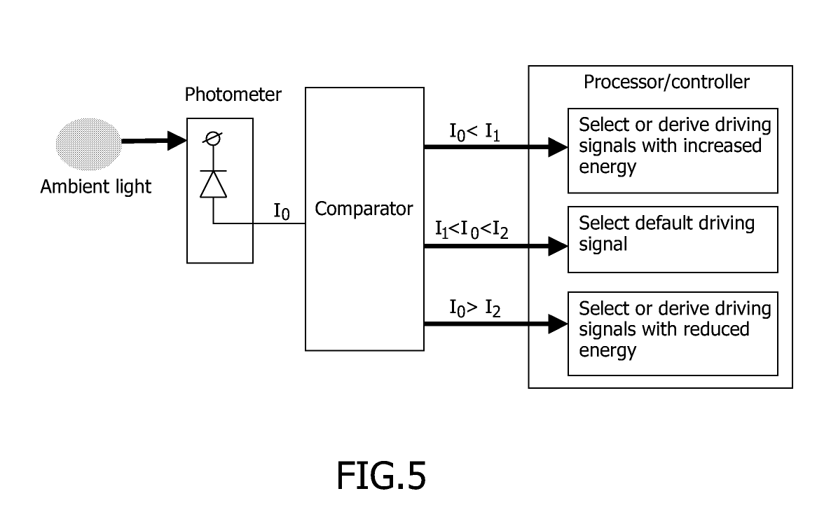

FIG. 5 shows a schematic diagram of compensating brightness change upon ambient light change using a photometer;

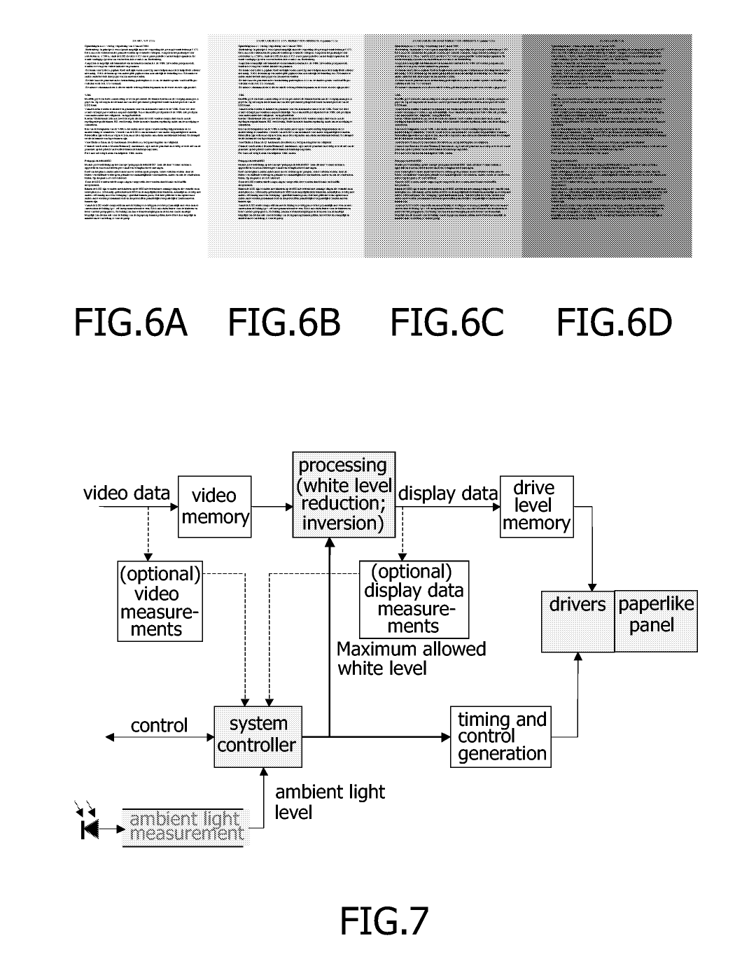

FIGS. 6A-6D show A4-pages of black text on “white” background used for the experiment: 100% white (FIG. 6A); 75% white (FIG. 6B); 50% white (FIG. 6C) and 22% white (FIG. 6D);

FIG. 7 shows an example of an ambient light adaptation scheme; and

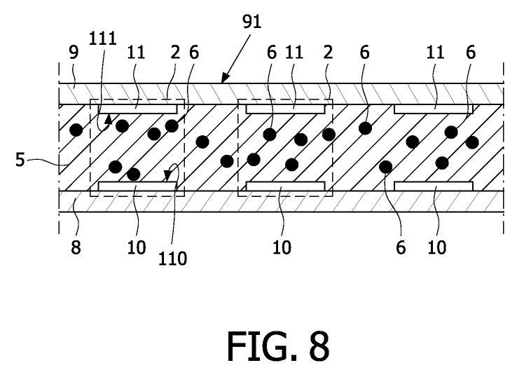

FIG. 8 shows diagrammatically a cross-sectional view along II-II in FIG. 1, the cross-sectional view representing a layout of the pixel.

In all the Figures corresponding parts are referenced to by the same reference numerals.

FIG. 1 shows a reflective display panel 1 arranged to modulate ambient light for displaying an image. The display panel 1 has a plurality of pixels 2 and a controller. Preferably, the pixels 2 are arranged along substantially straight lines in a two-dimensional structure. Other arrangements of the pixels 2 are possible, e.g. a honeycomb arrangement. In an active matrix embodiment, the pixels 2 may further comprise switching electronics, for example, thin film transistors (TFTs), diodes, MIM devices or the like. The pixels may further comprise separate storage capacitors, e.g. a capacitor, to hold the applied data voltage after addressing.

The display panel 1 has a viewing surface 91 for being viewed by a viewer. Each pixel has a brightness which corresponds to an extreme brightness level, e.g. black and white, or an intermediate brightness level, e.g. dark gray and light gray.

The controller is arranged for providing the pixels 2 with brightnesses corresponding to image content and depending on a condition of the ambient light for displaying the image. The controller has e.g. for each pixel 2 electrodes for receiving a drive signal, e.g. a potential difference, and drive means 100 arranged to control the drive signals.

For a reflective display panel, the display brightness is the product of the illumination level and the reflectivity of the display panel. High-quality white paper has a reflection of 70-80%, and paper-like display panels are nowadays reaching levels above 60%, and will achieve true paper-like reflectivity shortly.

At sunlight conditions, a full white display panel gives such a high brightness (high illumination level times a high reflectivity) that it hurts to the human eye. As human prefers to read black letters on a white background, standard reading conditions on a prior art display panel operated in a standard manner as disclosed in U.S. Pat. No. 6,704,113 would thus not be acceptable: one would literally have to wear sunglasses to make it into “an enjoyable reading experience”.

In the display panel according to the invention the reflectivity of the display panel is reduced at high ambient light levels, e.g. the white level of a highly reflective paper-like (paper-white) display panel is adapted to the amount of ambient light for comfortable viewing. As an example, the white level is reduced by reducing the reflectivity of the white state, as is indicated in FIG. 2.

This can be achieved in various ways:

gamut mapping, e.g. by reducing the drive signal amplitude with a illumination dependent factor, i.e. by attenuating the whole drive signal with a factor, in the digital domain, as shown in FIG. 3A. This reduces all brightness levels with the same factor (except possibly for the very darkest state, when that has already the deepest black brightness level that the display panel can achieve);

an example of a gamut mapping strategy is a clustering to a number of colors which are predetermined based on the balancing of the visibility/beautiful rendering criterion and the eye straining criterion on the other hand. E.g. a priori a number of colours are predetermined for each luminance interval (for simplicity preferably equidistant; e.g. corresponding to 255/4 equidistant driving values from 0 upto 128 and spaced by two for a first average surround illuminance, and corresponding to 255/8 equidistant driving values up to 64 for a second average surround illuminance). The colors present in the picture are then mapped to these predetermined values.

a more advanced strategy first performs a clustering of the colors actually present in the picture and defines (or redefines the a priori determined) optimal final colors taking this into account. E.g. if the actual image content is dark already, a better rendering strategy can be used than just scaling/projecting the colors to the a priori determined final template colors.

by reducing the drive signal amplitude with an illumination dependent brightness level, i.e. by subtracting the same brightness level from all display drive signals (and clipping to the black brightness level for pixels with resulting negative brightness levels), as shown in FIG. 3B;

by clipping all bright brightness levels to an illumination dependent maximum brightness level in the digital domain. This clipping can be done “hard” (see FIG. 3C), or “soft” (FIG. 3D) to keep brightness level detail in the brighter areas. As an example for an 8-bit display: all brightness levels above 200 could be clipped at very high brightness, to reduce the maximum display brightness level from 255 to 200; or

by reducing the level of the drive signal (analogue amplitude or duty cycle in PWM- and subfield-driving schemes).

An important issue is that the contrast of the display panel may go down. In our approach the driving values are changed, e.g. everything is made darker, but then one loses a little bit in “drivable” contrast, which, by the way, is not so bad since under high illumination the eye itself is not so sensitive to small contrast/color variations anyway, i.e. the image transforming method (software) can take this into account to render an image optimally.

The resulting loss of contrast (in case the black brightness level is unchanged while the white brightness level is reduced, the contrast is reduced) is in general well acceptable. To compensate for the loss of contrast, the width of the black characters can be increased when reducing the maximum reflectivity. This can be done gradually, or by a switch between standard and bold face characters.

As an example, the drive signals for driving the display or driving a front light are adjusted according to the actual ambient light intensity so that the best acuity can be achieved under various ambient light conditions. The drive signals for various light intensities are e.g. experimentally generated and provided in a memory, which may be manually or automatically selected upon the use of the display panel.

In one approach, a photometer or photodiode is incorporated in the panel, capable of measuring the actual ambient light intensity illuminated on the front screen, i.e. second substrate 9. The measured light intensity is compared with pre-stored values, upon which the correct drive signals are selected or derived through the controller so that a brightness corresponding to the most comfortable readability or the best acuity can be obtained, irrespective to the ambient light intensity. For example, when one reads the panel under (strong) sunlight, the desired brightness can be obtained by using an adjusted display drive signal with reduced driving energy (voltage×time) so that the readability remains comfortable, protecting the user's eyes from possible sun damages. In contrast, when one reads the panel under dark ambient light, the desired brightness can be obtained by using an adjusted front light with an increased light output (assume such a front light available on the panel). In this way, the user can obtain an enhanced experience in reading an electronic book than reading a convention paper book.

In another approach, the panel is provided with pre-designed a few default values allowing a user to select one of these default values according to an estimated lighting condition. In this case, a photometer need not be used.

This invention is enabled by the fact that the brightness of a reflective display is determined by the driving energy, defined by the voltage level times time, at a pre-defined illuminating condition or at a reference lighting condition, i.e. R(brightness)=I(light intensity)*D(driving energy). What is finally of importance is the luminance which goes from the display to the eye, which is a function of the illuminance of the ambient light and the current reflectance of a pixel (under the present driving value, this takes into account any gamma function of the display panel). In this text the word intensity is also used in the place of illuminance of the ambient light. Usually, the brightness decreases with a decrease of the driving energy under the same lighting condition so the brightness may remain substantially constant by decreasing the driving energy upon an increase of the lighting intensity, or by increasing the driving energy upon a decrease of the light intensity. However, when the maximum brightness for example for white state is already achieved at a reference light intensity, an increase of the driving energy would not any more help to maintain the brightness with a decreased ambient light intensity. In this case, the brightness may be maintained by introducing a front light and by increasing the front light output with a decreased ambient light, as illustrated in FIG. 4.

FIG. 4 shows schematic of a correlation between the ambient light intensity and brightness with three (I, II, III) clear regions divided by two threshold values: T₁=a threshold value for low readability below which the book is not readable as it becomes too dark at a light intensity lower than I1 and T₂=a threshold value for the maximum acceptable brightness level, above which the book not readable as it becomes too bright at a light intensity higher than I2. The region II between T1 and T2 are highly readable as the light intensities in this range give a brightness range highly acceptable by a user, as human eyes are tolerant enough to accept certain variations. It is therefore not necessary to keep the brightness constant within the region as a user practically experiences when reading a paper-book. However, when brightness is outside this range, the user experiences an uncomfortable reading as the panel becomes too dark or too bright, compensation is enabled by the present invention.

In FIG. 4, a correlation between the ambient light intensity and driving energy is also illustrated, according to the present invention, for achieving a substantially constant brightness such as the middle point M. At a higher light intensity, the driving energy is decreased and at a lower light intensity it is increased. It is important to note that the driving energy decreases with a higher speed at a light intensity beyond I2 than between I1 and I2 because the brightness has to be brought back to a level lower than the upper threshold value T2. For example, a user reads an e-book under strong sunlight (far above I2) with white state as the background, occupying usually more than 60% of the total area like in a conventional paper book page, and he experiences the brightness far above the T2 level. The driving energy for driving the display panel to white has to be reduced so that the brightness reaches a level below T2. When the light intensity is between I1 and I2, the need to compensate the brightness is minimum because of human eyes tolerance. However, if a user wants to achieve a constant or more comfortable brightness with a decreased light intensity, the driving energy may also be increased as indicated in FIG. 4 (the smaller slope indicates a lower need). If a user is willing to accept the brightness variations in this range as he is use to in reading familiar paper books, a constant driving energy may be applied for example using the one designed for the middle level M. So, a user can make his own choice for achieving an optimal reading. At a light intensity below I1, one may further increase the driving energy to achieve better brightness. However, if the intrinsic maximum brightness for example for full white state is already achieved, any increase in driving energy will not increase the brightness. In this case, a front light may be switched on preferably with a controllable output as indicated in FIG. 4. The driving energies at various light intensities can be experimentally measured, which may be provided as a look-up table list or a fitting function. The correct drive signals may be directly selected from the list or derived using the help of the fitting function when the device is used.

FIG. 5 shows a schematic diagram of compensating brightness change upon ambient light change using a photometer. The incoming ambient light falling onto the front screen of the display panel is measured using a photometer. One or more photometers or photodiodes may be incorporated in the panel anywhere near or on the screen. The measured light intensity is compared with a pre-stored list in a comparator. According to the comparing results, the correct drive signals suitable for the measured light intensity are selected or derived through the controller. If the measured intensity (I₀) of the ambient light is smaller than the minimal threshold value (I₁) then the drive signals with an increased energy are usually used. This means an increasing in driving time and/or driving voltage for the display drive signals or an increasing in front light output by increasing the voltage. When the measured intensity level is between the minimal threshold value (I₁) and the maximum threshold value (I₂) the default drive signals may be selected, i.e. no adjustment. When the measured intensity is larger than the maximum threshold value (I₂) then the drive signals with a decreased energy will usually be used. This means a decreasing in driving time and/or driving voltage for the display drive signals.

It is also possible to couple a clock function with the drive signals to achieve a variable brightness as a function of time. The brightness may be manually or automatically adjusted by selecting different drive signals upon an increase of reading time, to for example reduce tiring from reading. For example, when reading or watching the panel for a longer time, the drive signals with lower driving energy may be manually or automatically selected for obtaining a lower brightness. For a mobile phone, very short time reading, a high brightness may be desired but after a longer time the brightness can be decreased.

It is also possible to not use a photometer in the panel. In stead, the panel is provided with pre-designed a few default driving signals corresponding to various lighting conditions allowing a user to select one of these default values according to an estimated lighting condition by for example pressing a selection button, a button “Brightness” or “Ambient” on the panel may be introduced for example.

In another embodiment the drive signals are inverted at very bright conditions, leading to white letters on a black background. This is a reasonable solution for an electronic book with only two brightness levels per pixel, e.g. only black and white, but is less preferred when more brightness levels are used, as it changes also pictures into their negatives.

An experiment has been performed at a bright, unclouded, sunny day in the Netherlands. A4 sheets of paper with black text on white laser-printer paper were used. This paper has a reflectivity of about 70-75%. The test material was prepared for a display having a gamma of 2.2. A brightness level of 255 for full white (“100% full paper reflectivity”), 0.75^{(1/2.2)}×255=223 for 75% of the full paper reflectivity, 186 for 50%, and 128 for 22% is used. The test pages are shown in FIGS. 6A-6D.

The standard printed page on full white background (FIG. 6A) is clearly too bright to read in direct bright sunlight, also after trying to adapt to its high brightness for several minutes.

The page with a reduced maximum brightness to 75% (FIG. 6B) is acceptable, although maybe still a bit too bright. When reduced to 50% (FIG. 6C), the paper is perceived a bit grayish, and when reduced even further (FIG. 6D), the paper is clearly gray and also the contrast reduction is unacceptable.

It has been concluded that for this experiment the optimal brightness reduction is to reflectivities between 75% and 50% of the full paper reflection. At these reflectivities, the loss in contrast is not yet disturbing, although noticeable in the 50% case.

The functioning and features of the display panel according to the invention is shown schematically in FIG. 7. An ambient light sensor gives a level to the controller, which determines the maximum reflectivity. The drive signals are then modified according to one of the methods described above (see e.g. FIGS. 3A-3D). The (system) controller can use image measurements, (user) control such as keyboard input and ambient light condition measurements. Optionally, the controller can be extended to also depend on the image content from measurements on the incoming video (e.g. to determine whether the white level should be reduced or whether the image should be inverted) or on the drive signals (e.g. to detect whether a lot of pixels have been clipped, and then adjust the clipping strategy to prevent that in the next frames).

The video memory and the drive signal memory that are shown in FIG. 7 can be a full frame memory, a line buffer, or completely absent, depending on allowable system cost and required performance/featuring. The control loop can be feedforward as well as feedback.

The drive method can be used for display panels with pulse amplitude modulation, pulse width modulation, and combined modulation schemes (such as the “integrated drive” method explained below for E-ink displays), as well as for subfield driven displays.

Apart from full autonomous system control, also user control is possible. The user can e.g. manually operate a switch to reduce the maximum reflectivity, the device being provided with e.g. a few pre-designed default values allowing the user to select one of these default values according to an estimated lighting condition. In this case, a photometer is not used.

In an alternative, the user can e.g. switch between the standard black-on-white or alternative white-on-black mode.

The invention can be applied to any highly reflective display, notably those used for electronic reading and positioned for outdoor use.

An example is an electrophoretic display, such as those based on E-ink, used in e.g. Sony's LIBRIE e-book.

FIGS. 1 and 8 show an example of an electrophoretic display panel 1 having a first substrate 8, a second transparent opposed substrate 9 and a plurality of pixels 2. An electrophoretic medium 5, having charged particles 6 in a fluid, is present between the substrates 8,9. A first and a second electrode 10,11 are associated with each pixel 2 for receiving a potential difference. In FIG. 8 the first substrate 8 has for each pixel 2 a first electrode 10, and the second substrate 9 has for each pixel 2 a second electrode 11. The display panel 1 has a viewing surface 91 for being viewed by a viewer. The charged particles 6 are able to occupy extreme positions near the electrodes 10,11 and intermediate positions in between the electrodes 10,11. Each pixel 2 has a brightness determined by the position of the charged particles 6 between the electrodes 10,11. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. The fluid may be a liquid or a gas. As an example, the electrophoretic medium 5 comprises negatively charged black particles 6 in a white fluid. When the charged particles 6 are in a first extreme position, i.e. near the first electrode 10, as a result of the potential difference being e.g. 15 Volts, the brightness of the pixel 2 is e.g. white. When the charged particles 6 are in a second extreme position, i.e. near the second electrode 11, as a result of the potential difference being of opposite polarity, i.e. −15 Volts, the brightness of the pixel 2 is black. When the charged particles 6 are in one of the intermediate positions, i.e. in between the electrodes 10,11, the pixel 2 has one of the intermediate brightnesses, e.g. light gray, middle gray and dark gray, which are gray levels between white and black. The intermediate brightnesses may be obtained by providing the particles 6 with a different energy (energy is defined as the product of potential difference and time duration of the potential difference).

The controller is arranged for providing the pixels 2 with brightnesses corresponding to image content and depending on a condition of the ambient light for displaying the image. The controller has for each pixel 2 electrodes 10,11 for receiving a potential difference. Furthermore, the controller has drive means 100 being arranged to control the potential differences. In this case, each one of the electrodes 10,11 has a substantially flat surface 110,111 facing the medium 5. Furthermore, in this layout the electrodes 10,11 are arranged to enable the particles 6 to move in a plane perpendicular to the viewing surface 91.

The electrophoretic display panel is addressed in a kind of “integrated pulse” drive where after a display erase sequence (setting the whole display panel in a well-defined state, usually black), the wanted brightness level is built up by a sequence of data pulses of positive (pixel becomes whiter, as white particles move to viewer and black particles move away from the viewer), negative (becomes blacker, as black particles move to viewer) or zero (no particle movement) potential difference of certain length. The resulting brightness level is given by brightness=∫V(t)·t dt. It is thus possible to reduce the maximum display brightness level by e.g. ending all sequences with the same ambient light level dependent-duration of drive towards black: this gives a simple method to implement the strategy of FIG. 4B. Note that this also allows to adapt to brighter environment without refreshing the whole display panel line-by-line: a bit of gray can be added to an already displayed image by just driving the whole display panel at once towards black for a certain amount of time). The strategy of FIG. 3A can be implemented by reducing the (positive and negative) potential differences with the same factor, or by reducing the period of the driving sequence. Another example is a rotating ball display panel, such as the “SmartPaper” display panel from Gyricon.

Another example is an electrochromic display panel, such as the display panel from Ntera.

Another example is a subfield-driven paper-like display panel based on micro electromechanical systems (MEMS), such as Iridigm's “Digital Paper” Display panel, see e.g. M. Miles et al., Digital Paper for Reflective Displays, Digest SID'02 session 10.1, p. 115-118. (Iridigm).

Another example is an electrowetting display, such as the display from Philips, see B. J. Feenstra, R. A. Hayes and M. W. J. Prins, Display Device, PCT-Application WO 03/00196.

1. A reflective display panel (1) arranged to modulate ambient light for displaying an image, comprising a pixel (2) and a controller (10,11,100), the controller (10,11,100) being arranged for rendering the pixel (2) with a brightness corresponding to image content and depending on a condition of the ambient light for displaying the image.

2. A display panel (1) as claimed in claim 1 characterized in that the controller (10,11,100) is arranged for controlling the brightness in dependence of an intensity of the ambient light.

3. A display panel (1) as claimed in claim 2 characterized in that the brightness is a decreasing function of the intensity.

4. A display panel (1) as claimed in claim 3 characterized in that the function is substantially linear.

5. A display panel (1) as claimed in claim 3 characterized in that the function is a logarithm.

6. A display panel (1) as claimed in claim 2 characterized in that the brightness is:
a constant function of the intensity if the intensity is below a predetermined intensity, and
a decreasing function of the intensity if the intensity is larger than the predetermined intensity.

7. A display panel (1) as claimed in claim 1 characterized in that the controller (10,11,100) comprises drive means (100) and pixel electrodes (10,11) for receiving a drive signal, the drive means (100) being arranged to supply the drive signal for controlling the brightness for displaying the image.

8. A display panel (1) as claimed in claim 7 characterized in that the drive means (100) comprises
an image content transformer for transforming the image content into a transformed image content, the transformed image content corresponding to the image content in dependence of the condition of the ambient light; and
a transformed image content drive waveform generator for generating a drive signal corresponding to the transformed image content, the drive signal corresponding to the transformed image content being supplied as the drive signal for controlling the brightness for displaying the image.

9. A display panel (1) as claimed in claim 8 characterized in that the image content transformer is arranged to apply a gamut mapping to the image from the original displayed driving gamut (e.g. R,G,B=[0, 255]) to a reduced driving gamut, determined as a function of the intensity.

10. A display panel (1) as claimed in claim 9 characterized in that the reduced driving gamut consists of a number of driving value combinations predetermined as being optimal regarding a balance between visibility and eye strain.

11. A display panel (1) as claimed in claim 7 characterized in that the drive means (100) comprises
an image content drive waveform generator for generating a drive signal corresponding to the image content; and
a drive waveform transformer for transforming the drive signal corresponding to the image content into a transformed drive signal in dependence of the condition of the ambient light, the transformed drive signal being supplied to the pixel as the drive signal for controlling the brightness for displaying the image.

12. A display panel (1) as claimed in claim 7 characterized in that the drive signal is a potential difference.

13. A display panel (1) as claimed in claim 1 characterized in that the display panel (1) comprises a front light for generating light contributing to the ambient light.

14. A display panel (1) as claimed in claim 1 characterized in that the controller is able to control the light generated by the front light in dependence of the ambient light.

15. A display panel (1) as claimed in claim 1 characterized in that the pixel (2) comprises two liquids positioned over a reflective surface, the brightness depends on a relative coverage of the surface by the liquids, and the controller is arranged to control the relative coverage for displaying the image.

16. A display panel (1) as claimed in claim 1 characterized in that the pixel (2) comprises charged particles, the brightness depends on an orientation of the particles, and the controller is arranged to control the orientation of the particles for displaying the image.

17. A display panel (1) as claimed in claim 1 characterized in that the pixel (2) comprises an electrophoretic medium (5) comprising charged particles (6), the brightness depends on a position of the particles (6), and the controller (10,11,100) is arranged to control the position of the particles (6) for displaying the image.

18. A display panel (1) as claimed in claim 17 characterized in that the controller (10,11,100) comprises drive means (100) and pixel electrodes (10,11) for receiving a potential difference, the drive means (100) being arranged to supply the potential difference for controlling the position of the particles (6) for displaying the image.

19. A display panel (1) as claimed in claim 1 characterized in that the pixel (2) is one of a plurality of pixels (2) and the controller is arranged for providing the pixels (2) with brightnesses corresponding to the image content relating to the pixels (2) and depending on the condition of the ambient light for displaying the image.

20. A display panel (1) as claimed in claim 19 characterized in that the controller is arranged for controlling the brightnesses of the pixels in dependence of an intensity of the ambient light.

21. A display panel (1) as claimed in claim 20 characterized in that a sum of the brightnesses is a decreasing function of the intensity.

22. A display panel (1) as claimed in claim 20 characterized in that the brightnesses correspond to brightness inverted image content.

23. A display device comprising the display panel (1) as claimed in claim 1 and a circuitry to provide image information to the display panel (1).

24. A device as claimed in claim 23 characterized in that the device has a soft or hard button for allowing a user to adjust the brightness of the screen according to personal taste.

25. A controller for a reflective display panel (1), the display panel (1) being arranged to modulate ambient light for displaying an image, comprising a pixel (2), the controller being arranged for providing the pixel (2) with a brightness corresponding to image content and depending on a condition of the ambient light for displaying the image.

26. A method for driving a reflective display panel (1), the display panel (1) being arranged to modulate ambient light for displaying an image, comprising a pixel (2), the method comprising the step of providing the pixel (2) with a brightness corresponding to image content and depending on a condition of the ambient light for displaying the image.

27. A computer program comprising program code means for performing a method in accordance with the method as claimed in claim 26 when said program is run on a computer.
